(19) United States
(12) Patent Application Publication
(10) Pub. No.: US 2025/0242828 A1
(43) Pub. Date: Jul. 31, 2025

(54) Driving Behavior Analysis and Correction

(71) Applicant: Nissan North America, Inc., Franklin, TN (US)

(72) Inventors: Erik Lee St. Gray, Tacoma, WA (US); Corey Heath, Scottsdale, AZ (US); Mark Bailey, Seattle, WA (US); Stefan Witwicki, San Carlos, CA (US)

(21) Appl. No.: 18/428,974

(22) Filed: Jan. 31, 2024

(51) Int. Cl. B60W 50/16; B60W 40/09; B60W 50/14

(52) U.S. Cl. CPC B60W 50/16; B60W 40/09; B60W 2050/143; B60W 2050/146

(57) ABSTRACT

Monitoring driving characteristics by a first sensor and environmental characteristics by a second sensor, and determining, based on data of the first sensor and data of the second sensor, a deviant driving characteristic and an associated environmental characteristic. Further determining a deviant driving behavior based on the deviant driving characteristic and the associated environmental characteristic, for example, based on repeated instances of the deviant driving characteristic and the associated environmental characteristic. Indicating, to a driver of the vehicle, a corrective action for correcting the deviant driving characteristic, where the indication may be via a user interface of the vehicle or of a mobile device. In some implementations, the driver can review determined deviant driving behaviors via an application and provide to the application a driving goal for focused correction of certain deviant driving behaviors.

### TECHNICAL FIELD

This disclosure relates generally to driving behavior analysis and correction, and more particularly, to detecting deviant driving behaviors and indicating corrective action.

### BACKGROUND

There are many aspects to consider when driving a vehicle, for example, safety, efficiency, and wear-and-tear. However, a driver may neglect these considerations, for example, if the driver is in a hurry, if the driver is distracted, or if the driver has simply developed bad driving habits. Many modern vehicles include safety features to help prevent accidents, for example, by providing warnings to the driver, such as flashing blind-spot warning lights, or by taking immediate and/or temporary control of the vehicle, such as executing emergency braking. However, these safety features tend to be spontaneous and reactive, so they typically do not provide repetitive feedback to the driver to cause the driver to develop safer driving habits. Further, these safety features generally focus on avoiding accidents, so they do not provide feedback to the driver concerning wear-and-tear on the vehicle or driving efficiency.

### SUMMARY

Disclosed herein are aspects, features, elements, implementations, and embodiments of a method, a system, and a non-transitory computer-readable medium for detecting deviant driving behaviors (i.e., undesired driving behaviors), for example, those that can result in unsafe driving, inefficient driving, premature wear-and-tear of the vehicle, and further, to provide timely and/or repetitive feedback to the driver for causing the driver to recognize and correct deviant driving behaviors.

Many modern vehicles include sensors that monitor driving characteristics, such as speed sensors, acceleration sensors, braking sensors, motor revolutions per minute (RPM) sensors, wheel traction/slip sensors, and so on. Further, many modern vehicles include sensors that monitor environmental conditions, or characteristics, such as an exterior camera, a lidar, a radar, a sonar, an infrared (IR) sensor, an ultrasonic sensor, an interior camera, and a global navigation satellite system (GNSS) (e.g., a global positioning system (GPS)). The data collected by these sensors can be synthesized and analyzed to detect deviant driving characteristics and respective associated environmental characteristics, and further, to detect deviant driving behaviors based on the deviant driving characteristics and respective associated environmental characteristics. User-interface devices, such as in-vehicle infotainment (IVI) displays and/or mobile phone displays, can be used to communicate detection of, and/or corrective action for, deviant driving behaviors. Further, in-vehicle user-interface devices, such as IVI displays, speakers, seat vibrators, and/or cabin lights, as well as user-interface devices not integrated within the vehicle, such as mobile phone displays and/or mobile phone speakers, can be used to provide targeted feedback and/or reminders to the driver when deviant driving behaviors and respective associated environmental characteristics are detected. The deviant driving behaviors can be determined in several ways, for example, a vehicle (or component) manufacturer can define deviant driving behaviors or a system (within and/or external to the vehicle) can learn deviant driving behaviors using, for example, via a machine learning and/or artificial intelligence model executing on a processor within or external to the vehicle.

Variations in these and other aspects, features, elements, implementations, and embodiments of the methods, apparatus, procedures, and algorithms disclosed herein are described in further detail hereafter.

### BRIEF DESCRIPTION OF THE DRAWINGS

The various aspects of the methods and systems disclosed herein will become more apparent by referring to the examples provided in the following description and drawings in which like reference numbers refer to like elements unless otherwise noted.

FIG. 1 is a diagram of an example of a portion of a vehicle in which the aspects, features, and elements disclosed herein may be implemented.

FIG. 2 is a diagram of an example of a portion of a vehicle transportation and communication system in which the aspects, features, and elements disclosed herein may be implemented.

FIG. 3 is a block diagram of an example internal configuration of a computing device of an electronic computing and communications system in which the aspects, features, and elements disclosed herein may be implemented.

FIG. 4 is a block diagram of an example of a system for driving behavior analysis and correction.

FIG. 5 is a flowchart of an example of a process for detecting deviant driving behaviors and indicating corrective action.

### DETAILED DESCRIPTION

To describe some implementations in greater detail, reference is made to the following figures.

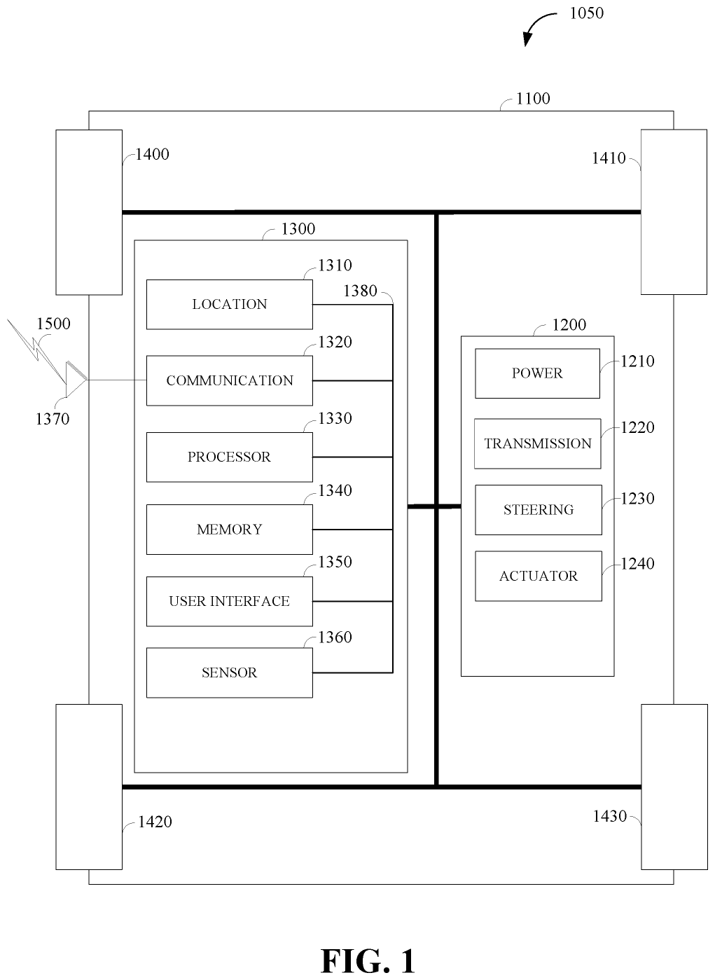

FIG. 1 is a diagram of an example of a vehicle 1050 in which the aspects, features, and elements disclosed herein may be implemented. The vehicle 1050 may include a chassis 1100, a powertrain 1200, a controller 1300, wheels 1400/1410/1420/1430, or any other element or combination of elements of a vehicle. Although the vehicle 1050 is shown as including four wheels 1400/1410/1420/1430 for simplicity, any other propulsion device or devices, such as a propeller or tread, may be used. In FIG. 1, the lines interconnecting elements, such as the powertrain 1200, the controller 1300, and the wheels 1400/1410/1420/1430, indicate that information, such as data or control signals, power, such as electrical power or torque, or both information and power, may be communicated between the respective elements. For example, the controller 1300 may receive power from the powertrain 1200 and communicate with the powertrain 1200, the wheels 1400/1410/1420/1430, or both, to control the vehicle 1050, which can include accelerating, decelerating, steering, or otherwise controlling the vehicle 1050.

The powertrain 1200 includes a power source 1210, a transmission 1220, a steering unit 1230, a vehicle actuator 1240, or any other element or combination of elements of a powertrain, such as a suspension, a drive shaft, axles, or an exhaust system. Although shown separately, the wheels 1400/1410/1420/1430 may be included in the powertrain 1200. A braking system may be included in the vehicle actuator 1240.

The power source 1210 may be any device or combination of devices operative to provide energy, such as electrical energy, chemical energy, or thermal energy. For example, the power source 1210 includes an engine, such as an internal combustion engine, an electric motor, or a combination of an internal combustion engine and an electric motor, and is operative to provide energy as a motive force to one or more of the wheels 1400/1410/1420/1430. In some embodiments, the power source 1210 includes a potential energy unit, such as one or more dry cell batteries, such as nickel-cadmium (NiCd), nickel-zinc (NiZn), nickel metal hydride (NiMH), lithium-ion (Li-ion); solar cells; fuel cells; or any other device capable of providing energy.

The transmission 1220 receives energy from the power source 1210 and transmits the energy to the wheels 1400/1410/1420/1430 to provide a motive force. The transmission 1220 may be controlled by the controller 1300, the vehicle actuator 1240 or both. The steering unit 1230 may be controlled by the controller 1300, the vehicle actuator 1240, or both and controls the wheels 1400/1410/1420/1430 to steer the vehicle. The vehicle actuator 1240 may receive signals from the controller 1300 and may actuate or control the power source 1210, the transmission 1220, the steering unit 1230, or any combination thereof to operate the vehicle 1050.

In some embodiments, the controller 1300 includes a location unit 1310, an electronic communication unit 1320, a processor 1330, a memory 1340, a user interface 1350, a sensor 1360, an electronic communication interface 1370, or any combination thereof. Although shown as a single unit, any one or more elements of the controller 1300 may be integrated into any number of separate physical units. For example, the user interface 1350 and processor 1330 may be integrated in a first physical unit and the memory 1340 may be integrated in a second physical unit. Although not shown in FIG. 1, the controller 1300 may include a power source, such as a battery. Although shown as separate elements, the location unit 1310, the electronic communication unit 1320, the processor 1330, the memory 1340, the user interface 1350, the sensor 1360, the electronic communication interface 1370, or any combination thereof can be integrated in one or more electronic units, circuits, or chips.

In some embodiments, the processor 1330 includes any device or combination of devices capable of manipulating or processing a signal or other information now existing or hereafter developed, including optical processors, quantum processors, molecular processors, or a combination thereof. For example, the processor 1330 may include one or more special purpose processors, one or more digital signal processors, one or more microprocessors, one or more controllers, one or more microcontrollers, one or more integrated circuits, one or more an application-specific integrated circuits (ASICs), one or more field-programmable gate arrays (FPGAs), one or more programmable logic arrays (PLAs), one or more programmable logic controllers (PLCs), one or more state machines, or any combination thereof. The processor 1330 may be operatively coupled with the location unit 1310, the memory 1340, the electronic communication interface 1370, the electronic communication unit 1320, the user interface 1350, the sensor 1360, the powertrain 1200, or any combination thereof. For example, the processor may be operatively coupled with the memory 1340 via a communication bus 1380.

In some embodiments, the processor 1330 may be configured to execute instructions including instructions for remote operation which may be used to operate the vehicle 1050 from a remote location including a data-processing center. The instructions for remote operation may be stored in the vehicle 1050 or received from an external source such as a traffic management center, or server computing devices, which may include cloud-based server computing devices. The processor 1330 may be configured to execute instructions for following a projected path as described herein.

The memory 1340 may include any tangible non-transitory computer-usable or computer-readable medium, capable of, for example, containing, storing, communicating, or transporting machine readable instructions or any information associated therewith, for use by or in connection with the processor 1330. The memory 1340 is, for example, one or more solid state drives, one or more memory cards, one or more removable media, one or more read only memories, one or more random access memories, one or more solid-state drives, one or more disks, including a hard disk, a floppy disk, an optical disk, a magnetic or optical card, or any type of non-transitory media suitable for storing electronic information, or any combination thereof.

The electronic communication interface 1370 may be a wireless antenna, as shown, a wired communication port, an optical communication port, or any other wired or wireless unit capable of interfacing with a wired or wireless electronic communication medium 1500.

The electronic communication unit 1320 may be configured to transmit or receive signals via the wired or wireless electronic communication medium 1500, such as via the electronic communication interface 1370. Although not explicitly shown in FIG. 1, the electronic communication unit 1320 is configured to transmit, receive, or both via any wired or wireless communication medium, such as radio frequency (RF), ultraviolet (UV), visible light, fiber optic, wire line, or a combination thereof. Although FIG. 1 shows a single one of the electronic communication unit 1320 and a single one of the electronic communication interface 1370, any number of communication units and any number of communication interfaces may be used. In some embodiments, the electronic communication unit 1320 can include a dedicated short-range communications (DSRC) unit, a wireless safety unit (WSU), IEEE 802.11p (Wifi-P), a cellular communication unit such as a long-term evolution (LTE) or 5G transceiver, or a combination thereof.

The location unit 1310 may determine geolocation information, including but not limited to longitude, latitude, elevation, direction of travel, or speed, of the vehicle 1050. For example, the location unit includes a global positioning system (GPS) unit, such as a wide area augmentation system (WAAS) enabled National Marine-Electronics Association (NMEA) unit, a radio triangulation unit, or a combination thereof. The location unit 1310 can be used to obtain information that represents, for example, a current heading of the vehicle 1050, a current position of the vehicle 1050 in two or three dimensions, a current angular orientation of the vehicle 1050, or a combination thereof.

The user interface 1350 may include any unit capable of being used as an interface by a person, including any of a virtual keypad, a physical keypad, a touchpad, a display, a touchscreen, a speaker, a microphone, a video camera, a sensor, and a printer. The user interface 1350 may be operatively coupled with the processor 1330, as shown, or with any other element of the controller 1300. Although shown as a single unit, the user interface 1350 can include one or more physical units. For example, the user interface 1350 includes an audio interface for performing audio communication with a person, and a touch display for performing visual and touch based communication with the person.

The sensor 1360 may include one or more sensors, such as an array of sensors, which may be operable to provide information that may be used to control the vehicle. The sensor 1360 can provide information regarding current operating characteristics of the vehicle or its surrounding. The sensors 1360 include, for example, a speed sensor, acceleration sensors, a steering angle sensor, traction-related sensors, braking-related sensors, or any sensor, or combination of sensors, that is operable to report information regarding some aspect of the current dynamic situation of the vehicle 1050.

In some embodiments, the sensor 1360 may include sensors that are operable to obtain information regarding the physical environment surrounding the vehicle 1050. For example, one or more sensors detect road geometry and obstacles, such as fixed obstacles, vehicles, cyclists, and pedestrians. In some embodiments, the sensor 1360 can be or include one or more video cameras, laser-sensing systems, infrared-sensing systems, acoustic-sensing systems, or any other suitable type of on-vehicle environmental sensing device, or combination of devices, now known or later developed. In some embodiments, the sensor 1360 and the location unit 1310 are combined.

Although not shown separately, the vehicle 1050 may include a trajectory controller. For example, the controller 1300 may include a trajectory controller. The trajectory controller may be operable to obtain information describing a current state of the vehicle 1050 and a route planned for the vehicle 1050, and, based on this information, to determine and optimize a trajectory for the vehicle 1050. In some embodiments, the trajectory controller outputs signals operable to control the vehicle 1050 such that the vehicle 1050 follows the trajectory that is determined by the trajectory controller. For example, the output of the trajectory controller can be an optimized trajectory that may be supplied to the powertrain 1200, the wheels 1400/1410/1420/1430, or both. In some embodiments, the optimized trajectory can control inputs such as a set of steering angles, with each steering angle corresponding to a point in time or a position. In some embodiments, the optimized trajectory can be one or more paths, lines, curves, or a combination thereof.

One or more of the wheels 1400/1410/1420/1430 may be a steered wheel, which is pivoted to a steering angle under control of the steering unit 1230, a propelled wheel, which is torqued to propel the vehicle 1050 under control of the transmission 1220, or a steered and propelled wheel that steers and propels the vehicle 1050.

A vehicle may include units, or elements not shown in FIG. 1, such as an enclosure, a Bluetooth® module, a frequency modulated (FM) radio unit, a Near Field Communication (NFC) module, a liquid crystal display (LCD) display unit, an organic light-emitting diode (OLED) display unit, a speaker, or any combination thereof.

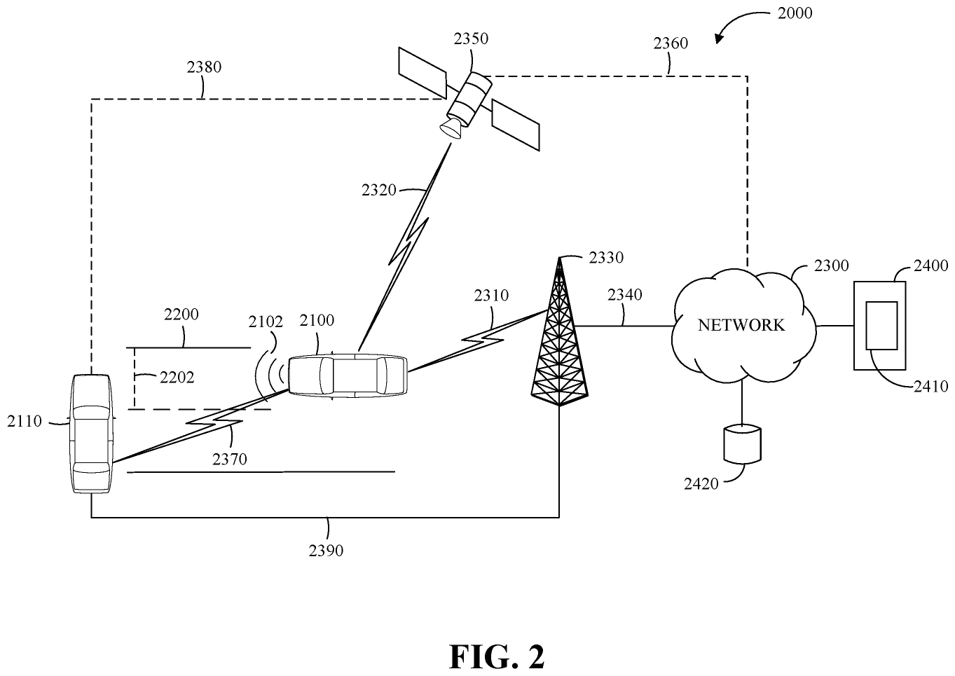

FIG. 2 is a diagram of an example of a portion of a vehicle transportation and communication system 2000 in which the aspects, features, and elements disclosed herein may be implemented. The vehicle transportation and communication system 2000 includes a vehicle 2100, such as the vehicle 1050 shown in FIG. 1, and one or more external objects, such as an external object 2110, which can include any form of transportation, such as the vehicle 1050 shown in FIG. 1, a pedestrian, cyclist, as well as any form of a structure, such as a building. The vehicle 2100 may travel via one or more portions of a transportation network 2200, and may communicate with the external object 2110 via one or more of an electronic communication network 2300. Although not explicitly shown in FIG. 2, a vehicle may traverse an area that is not expressly or completely included in a transportation network, such as an off-road area. In some embodiments the transportation network 2200 may include one or more of a vehicle detection sensor 2202, such as an inductive loop sensor, which may be used to detect the movement of vehicles on the transportation network 2200.

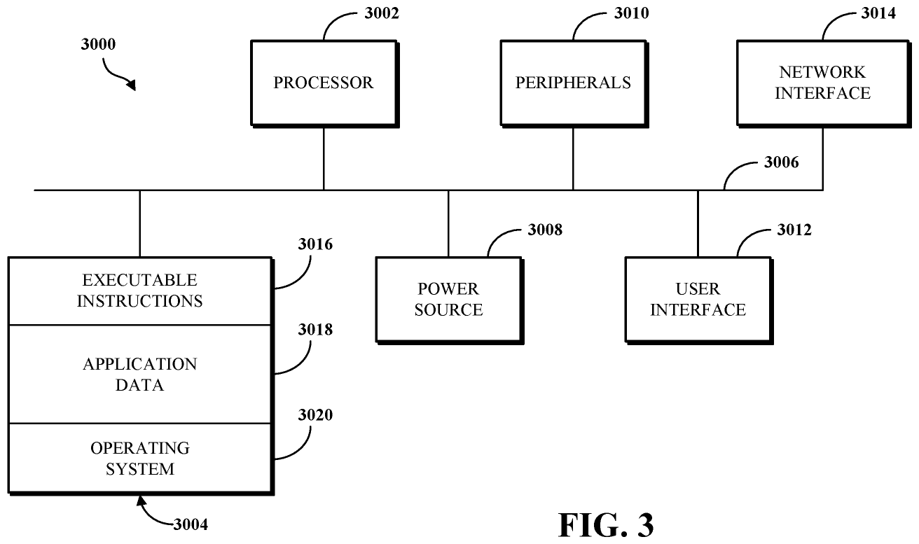

The electronic communication network 2300 may be a multiple-access system that provides for communication, such as voice communication, data communication, video communication, messaging communication, or a combination thereof, between the vehicle 2100, the external object 2110, and a data-processing center 2400. For example, the vehicle 2100 or the external object 2110 may send information to, or receive information from, the data-processing center 2400 or a database server 2420, via the electronic communication network 2300, such as information representing the transportation network 2200. The data-processing center 2400 includes a computing apparatus 2410, that includes some or all of the features of the computing device 3000 shown in FIG. 3. In some implementations, the data-processing center 2400 includes the database server 2420. The database server 2420 is configured for storing data, and it may be implemented by a suitable computer storage medium.

The data-processing center 2400 can monitor and coordinate the movement of vehicles, including autonomous vehicles. The data-processing center 2400 may monitor the state or condition of vehicles, such as the vehicle 2100, and external objects, such as the external object 2110. The data-processing center 2400 can receive vehicle data and infrastructure data including any of: vehicle velocity; vehicle location; vehicle operational state; vehicle destination; vehicle route; vehicle sensor data; external object velocity; external object location; external object operational state; external object destination; external object route; and external object sensor data.

Further, the data-processing center 2400 can establish remote control over one or more vehicles, such as the vehicle 2100, or external objects, such as the external object 2110. In this way, the data-processing center 2400 may tele-operate the vehicles or external objects from a remote location. The computing apparatus 2410 may exchange (send or receive) state data with vehicles, external objects, or computing devices such as the vehicle 2100, the external object 2110, or the database server 2420, via a wireless communication link such as the wireless communication link 2380 or a wired communication link such as the wired communication link 2390.

In some embodiments, the vehicle 2100 or the external object 2110 communicates via the wired communication link 2390, a wireless communication link 2310/2320/2370, or a combination of any number or types of wired or wireless communication links. For example, as shown, the vehicle 2100 or the external object 2110 communicates via a terrestrial wireless communication link 2310, via a non-terrestrial wireless communication link 2320, or via a combination thereof. In some implementations, a terrestrial wireless communication link 2310 includes an Ethernet link, a serial link, a Bluetooth link, an infrared (IR) link, an ultraviolet (UV) link, or any link capable of providing for electronic communication.

A vehicle, such as the vehicle 2100, or an external object, such as the external object 2110, may communicate with another vehicle, external object, or the data-processing center 2400. For example, a host, or subject, vehicle 2100 may receive one or more automated inter-vehicle messages, such as a basic safety message (BSM), from the data-processing center 2400, via a direct communication link 2370, or via an electronic communication network 2300. For example, data-processing center 2400 may broadcast the message to host vehicles within a defined broadcast range, such as three hundred meters, or to a defined geographical area. In some embodiments, the vehicle 2100 receives a message via a third party, such as a signal repeater (not shown) or another remote vehicle (not shown). In some embodiments, the vehicle 2100 or the external object 2110 transmits one or more automated inter-vehicle messages periodically based on a defined interval, such as one hundred milliseconds.

Automated inter-vehicle messages may include vehicle identification information, geospatial state information, such as longitude, latitude, or elevation information, geospatial location accuracy information, kinematic state information, such as vehicle acceleration information, yaw rate information, speed information, vehicle heading information, braking system state data, throttle information, steering wheel angle information, or vehicle routing information, or vehicle operating state information, such as vehicle size information, headlight state information, turn signal information, wiper state data, transmission information, or any other information, or combination of information, relevant to the transmitting vehicle state. For example, transmission state information indicates whether the transmission of the transmitting vehicle is in a neutral state, a parked state, a forward state, or a reverse state.

In some embodiments, the vehicle 2100 communicates with the electronic communication network 2300 via an access point 2330. The access point 2330, which may include a computing device, may be configured to communicate with the vehicle 2100, with the electronic communication network 2300, with the data-processing center 2400, or with a combination thereof via wired or wireless communication links 2310/2340. For example, an access point 2330 is a base station, a base transceiver station (BTS), a Node-B, an enhanced Node-B (eNode-B), a Home Node-B (HNode-B), a wireless router, a wired router, a hub, a relay, a switch, or any similar wired or wireless device. Although shown as a single unit, an access point can include any number of interconnected elements.

The vehicle 2100 may communicate with the electronic communication network 2300 via a satellite 2350, or other non-terrestrial communication device. The satellite 2350, which may include a computing device, may be configured to communicate with the vehicle 2100, with the electronic communication network 2300, with the data-processing center 2400, or with a combination thereof via one or more communication links 2320/2360. Although shown as a single unit, a satellite can include any number of interconnected elements.

The electronic communication network 2300 may be any type of network configured to provide for voice, data, or any other type of electronic communication. For example, the electronic communication network 2300 includes a local area network (LAN), a wide area network (WAN), a virtual private network (VPN), a mobile or cellular telephone network, the Internet, or any other electronic communication system. The electronic communication network 2300 may use a communication protocol, such as the transmission control protocol (TCP), the user datagram protocol (UDP), the internet protocol (IP), the real-time transport protocol (RTP) the Hyper Text Transport Protocol (HTTP), or a combination thereof. Although shown as a single unit, an electronic communication network can include any number of interconnected elements.

In some embodiments, the vehicle 2100 communicates with the data-processing center 2400 via the electronic communication network 2300, access point 2330, or satellite 2350. The data-processing center 2400 may include one or more computing devices, which are able to exchange (send or receive) data from: vehicles such as the vehicle 2100; external objects including the external object 2110; or storage devices such as the database server 2420.

In some embodiments, the vehicle 2100 identifies a portion or condition of the transportation network 2200. For example, the vehicle 2100 may include one or more on-vehicle sensors 2102, such as the sensor 1360 shown in FIG. 1, which includes a speed sensor, a wheel speed sensor, a camera, a gyroscope, an optical sensor, a laser sensor, a radar sensor, a sonic sensor (e.g., a microphone or acoustic sensor), a compass, or any other sensor or device or combination thereof capable of determining or identifying a portion or condition of the transportation network 2200.

The vehicle 2100 may traverse one or more portions of the transportation network 2200 using information communicated via the electronic communication network 2300, such as information representing the transportation network 2200, information identified by one or more on-vehicle sensors 2102, or a combination thereof. The external object 2110 may be capable of all or some of the communications and actions described above with respect to the vehicle 2100.

For simplicity, FIG. 2 shows the vehicle 2100 as the host vehicle, the external object 2110, the transportation network 2200, the electronic communication network 2300, and the data-processing center 2400. However, any number of vehicles, networks, or computing devices may be used. In some embodiments, the vehicle transportation and communication system 2000 includes devices, units, or elements not shown in FIG. 2. Although the vehicle 2100 or external object 2110 is shown as a single unit, a vehicle can include any number of interconnected elements.

Although the vehicle 2100 is shown communicating with the data-processing center 2400 via the electronic communication network 2300, the vehicle 2100 (and external object 2110) may communicate with the data-processing center 2400 via any number of direct or indirect communication links. For example, the vehicle 2100 or external object 2110 may communicate with the data-processing center 2400 via a direct communication link, such as a Bluetooth communication link. Although, for simplicity, FIG. 2 shows one of the transportation network 2200, and one of the electronic communication network 2300, any number of networks or communication devices may be used. The vehicle 2100 (and external object 2110) can be monitored or coordinated by the data-processing center 2400, can be operated autonomously or by a human driver, and can exchange (send and receive) vehicle data relating to the state or condition of the vehicle and its surroundings including any of vehicle velocity (e.g., vehicle speed and vehicle trajectory, or heading); vehicle location; vehicle operational state; vehicle destination; vehicle route; vehicle sensor data; external object velocity; external object location, and so on.

FIG. 3 shows a block diagram of an example of a computing device 3000 capable of performing functions described later herein. The computing device 3000 includes components or units, such as a processor 3002, a memory 3004, a bus 3006, a power source 3008, peripherals 3010, a user interface 3012, a network interface 3014, other suitable components, or a combination thereof. One or more of the memory 3004, the power source 3008, the peripherals 3010, the user interface 3012, or the network interface 3014 can communicate with the processor 3002 via the bus 3006.

The processor 3002 is a central processing unit, such as a microprocessor, and can include single or multiple processors having single or multiple processing cores. Alternatively, the processor 3002 can include another type of device, or multiple devices, configured for manipulating or processing information. For example, the processor 3002 can include multiple processors interconnected in one or more manners, including hardwired or networked. The operations of the processor 3002 can be distributed across multiple devices or units that can be coupled directly or across a local area or other suitable type of network. The processor 3002 can include a cache, or cache memory, for local storage of operating data or instructions.

The memory 3004 includes one or more memory components, which may each be volatile memory or non-volatile memory. For example, the volatile memory can be random access memory (RAM) (e.g., a DRAM module, such as DDR SDRAM). In another example, the non-volatile memory of the memory 3004 can be a disk drive, a solid state drive, flash memory, or phase-change memory. In some implementations, the memory 3004 can be distributed across multiple devices. For example, the memory 3004 can include network-based memory or memory in multiple clients or servers performing the operations of those multiple devices.

The memory 3004 can include data for immediate access by the processor 3002. For example, the memory 3004 can include executable instructions 3016, application data 3018, and an operating system 3020. The executable instructions 3016 can include one or more application programs, which can be loaded or copied, in whole or in part, from non-volatile memory to volatile memory to be executed by the processor 3002. For example, the executable instructions 3016 can include instructions for performing techniques of this disclosure. In some implementations, the application data 3018 can include functional programs, such as a computational programs, analytical programs, database programs, and so on. The operating system 3020 can be, for example, Microsoft Windows®, Mac OS X®, or Linux®; an operating system for a mobile device, such as a smartphone or tablet device; or an operating system for a non-mobile device, such as a mainframe computer.

The power source 3008 provides power to the computing device 3000. For example, the power source 3008 can be an interface to an external power distribution system. In another example, the power source 3008 can be a battery, such as where the computing device 3000 is a mobile device or is otherwise configured to operate independently of an external power distribution system. In some implementations, the computing device 3000 may include or otherwise use multiple power sources. In some such implementations, the power source 3008 can be a backup battery.

The peripherals 3010 may include one or more sensors, detectors, or other devices configured for monitoring the computing device 3000 or the environment around the computing device 3000. For example, the peripherals 3010 can include a geolocation component, such as a global positioning system (GPS) location unit. In another example, the peripherals can include a temperature sensor for measuring temperatures of components of the computing device 3000, such as the processor 3002. In some implementations, the computing device 3000 can omit the peripherals 3010.

The user interface 3012 includes one or more input interfaces and/or output interfaces. An input interface may, for example, be a positional input device, such as a mouse, touchpad, touchscreen, or the like; a keyboard; or another suitable human or machine interface device. An output interface may, for example, be a display, such as a liquid crystal display, a cathode-ray tube, a light emitting diode display, or other suitable display.

The network interface 3014 provides a connection or link to a network (e.g., the electronic communication network 2300 shown in FIG. 2). The network interface 3014 can be a wired network interface or a wireless network interface. The computing device 3000 can communicate with other devices via the network interface 3014 using one or more network protocols, such as using Ethernet, transmission control protocol (TCP), internet protocol (IP), power line communication, an IEEE 802.X protocol (e.g., Wi-Fi, Bluetooth, or ZigBee), infrared, visible light, general packet radio service (GPRS), global system for mobile communications (GSM), code-division multiple access (CDMA), Z-Wave, another protocol, or a combination thereof. For example, the computing device 3000 can communicate with a database server, such as the database server 2420 of FIG. 2.

In the description herein, sentences describing the autonomous vehicle as taking an action (such as performing, determining, initiating, receiving, calculating, deciding, etc.) are to be understood that some appropriate module of the AV as taking the action. Such modules may be stored in a memory of the AV, such as the memory 1340 of FIG. 1, and executed by a processor, such as the processor 1330 of FIG. 1. Such modules may be partially or fully included in a controller apparatus, such as the computing apparatus 2410 of FIG. 2 and may be partially or fully executed by a processor of the AV, a processor of a data-processing center, or a combination thereof. For example, the statement “the AV determines a trajectory” can be understood to mean that “a module of the AV determines a trajectory” or “a trajectory planning module of the AV determines a trajectory.”

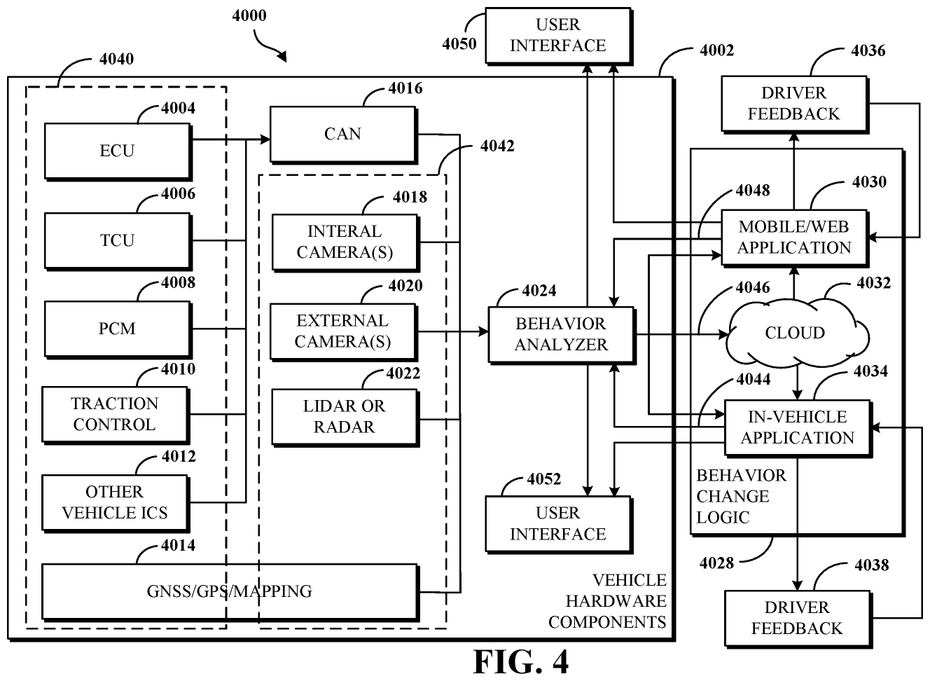

FIG. 4 shows a block diagram of an example of a system 4000 for driving behavior analysis and correction. Vehicle hardware components 4002 comprise one or more driving-characteristics sensors 4040 that monitor driving characteristics, including sensors included with or coupled to an engine control unit (ECU) 4004, a transmission control unit (TCU) 4006, a powertrain control module (PCM) 4008, a traction control unit 4010, a GNSS/GPS/mapping unit 4014, and other in-vehicle integrated circuits (ICs) 4012. In FIG. 4, the GNSS/GPS/mapping unit 4014 is shown as a single unit; however, the GNSS/GPS sensing component of the GNSS/GPS/mapping unit 4014 may be separate from the mapping component of the GNSS/GPS/mapping unit 4014. Further, the GNSS/GPS/mapping unit 4014 is shown as both a driving-characteristics sensor 4040 and an environmental-characteristics sensor 4042 because it may provide either driving data (e.g., vehicle speed) or environmental data (e.g., vehicle location, mapping data, etc.). The one or more driving-characteristics sensors 4040 may be, for example, the one or more sensors 1360 and/or the location unit 1310 of FIG. 1. Driving characteristics are characteristics of the vehicle and/or its components, for example, a vehicle speed; a vehicle acceleration; a vehicle braking; a vehicle yaw, pitch, or roll; a tire pressure; a wheel traction; a gear selection; an engine revolutions per minute; an engine temperature; a brake temperature; a tire temperature; a battery temperature; a battery state-of-charge; an undercarriage clearance; a suspension position; and so on. One or more of the driving-characteristics sensors 4040 may be coupled to a car-area network (CAN) 4016.

The vehicle hardware components 4002 further comprise one or more environmental-characteristics sensors 4042 that monitor environmental characteristics internal to the vehicle (e.g., inside a cabin of the vehicle) and/or external to the vehicle (e.g., outside the cabin), including one or more internal cameras 4018, one or more external cameras 4020, and lidar or radar 4022. As explained above, the GNSS/GPS/mapping unit 4014 may be included as an environmental-characteristics sensor 4042. Other sensors that monitor environmental conditions, not shown in FIG. 4, may include sonar, infrared, and ultrasonic. One or more of the environmental-characteristics sensors 4042 may be, for example, the sensors 1360 and/or the location unit 1310 of FIG. 1. Environmental characteristics are characteristics of the environment and inanimate and/or animate objects within the environment inside and/or outside the cabin of the vehicle, for example, a driver's gaze direction; a driver's gaze duration; a state of a traffic signal; a location of a traffic sign or signal; a location of a lane marker; a location of the vehicle, a location of one or more other vehicles; a curvature of a road; and so on. Some environmental characteristics may be determined with varying degrees of accuracy from either the driving-characteristics sensors 4040 or the environmental characteristics sensors 4042. For example, a curvature of a road (e.g., a radius of curvature) may be determined by the mapping data included with the GNSS/GPS/mapping unit 4014 or it may be determined by one or more of the external camera(s) 4020 or the lidar or radar 4022.

Driving data collected by the driving-characteristics sensors 4040 and environmental data collected by the environmental-characteristics sensors 4042 are provided to a behavior analyzer 4024 via one or more communication channels, such as wired or wireless communication channels. The behavior analyzer 4024 may be implemented via components that are integrated within the vehicle, such as the processor 1330 of FIG. 1, and/or via components that are external to the vehicle, such as the computing apparatus 2410 of the data-processing center 2400 of FIG. 2. The behavior analyzer 4024 synthesizes the driving data and the environmental data to determine, or detect, deviant driving characteristics and respective associated environmental characteristics. A deviant driving characteristic is a driving characteristic that deviates from baseline driving characteristics, for example, sudden braking, excessive g-forces during a turn, repetitive cycles of heavy acceleration and deceleration, excessive deflection of suspension springs, reduced undercarriage clearance, and so on. A deviant driving characteristic may be referred to as a “feature,” such that the behavior analyzer 4024 may detect features based on the driving data and the environmental data.

A driving characteristic by itself may not deviate from a baseline, but it may deviate from a baseline when associated environmental characteristic(s) are considered. As an example, driving at a speed of 60 miles per hour (MPH) by itself may not be a deviant driving characteristic, but driving at 60 MPH in a 25 MPH school zone—an environmental characteristic-could be a deviant driving characteristic that embodies by unsafe driving. In this example, the environmental-characteristics sensors 4042, such as the external camera(s) 4020, may capture and process an image of a school-zone or speed-limit sign and provide such environmental data to the behavior analyzer 4024. As another example, sudden braking by itself may not be a deviant driving characteristic, but sudden braking when approaching a red traffic light could be a deviant driving characteristic that may cause excessive and/or unnecessary wear-and—tear on the vehicle and/or inefficient driving (e.g., reduced miles per gallon (MPG)).

Baseline driving characteristics may be predefined, for example, by a manufacturer of a vehicle or component thereof, or baseline driving characteristics may be learned over time by training of a machine-learning model, e.g., a neural network. Methods of training of machine-learning models and associated computing hardware are known in the art and are therefore not discussed further herein.

As indicated by the preceding examples, a deviant driving characteristic by itself may not indicate a deviant driving behavior that warrants correction. For example, sudden braking when approaching a red traffic light is probably preferred over an alternative of driving through the red traffic light. But repeated instances of sudden braking when approaching a red traffic light may indicate that the driver is inattentive to traffic lights or the driver is unaware that unnecessary wear-and-tear on the vehicle can be reduced by coasting and/or easing the brakes when approaching red traffic lights. Thus, the behavior analyzer 4024 utilizes a memory, such as the memory 1340 of FIG. 1, to store previous driving data, previous environmental data, and/or previous deviant driving characteristics and their respective associated environmental characteristics. Further, the behavior analyzer 4024 analyzes current (i.e., most recent) driving data and/or environmental data in context to previous (i.e., less recent) driving data and/or environmental data, and the behavior analyzer 4024 utilizes a history of deviant driving characteristics and their respective associated environmental characteristics to determine patterns of deviant driving behavior, i.e., deviant driving behaviors. The behavior analyzer 4024 may utilize a memory, such as the memory 1340 of FIG. 1, to store deviant driver behaviors. Deviant driving behaviors, and/or deviant driving characteristics and respective environmental characteristics may be indexed by suitable parameters for later retrieval, such as by time, buy location, or by one or more behavior types or categories (e.g., safety categories, wear-and-tear categories, severity categories, frequency categories, age categories, and so on).

An example deviant driving behavior that the behavior analyzer 4024 may determine is sudden braking when approaching red traffic lights, indicated by many instances of the deviant driving characteristic of sudden braking associated with the environmental characteristic of approaching a red traffic light, as described earlier.

Another example of a deviant driving behavior that the behavior analyzer 4024 may determine is the vehicle entering turns at an excessive speed for a given radius of curvature of the road. In this example, the behavior analyzer 4024 may receive driving data, for example, vehicle speed from a speedometer, lateral acceleration from an accelerometer, and vehicle roll from a gyroscope (e.g., within or coupled to the engine control unit 4004 of FIG. 4). The behavior analyzer 4024 may receive environmental data, for example, a radius of curvature of the road on which the vehicle is driving from a GPS unit (e.g., the GNSS/GPS unit 4014 of FIG. 4). The behavior analyzer 4024 may record, in a memory (e.g., the memory 1340 of FIG. 1), instances of the vehicle entering turns at an excessive speed for a given radius of curvature of the turn, and determine, or detect, the deviant driving behavior after recording a predefined quantity of instances within a predefined duration.

Another example of a deviant driving behavior that the behavior analyzer 4024 may determine is the driver failing to check a blind spot when changing lanes. In this example, the behavior analyzer 4024 may receive driving data, for example, vehicle location and road lanes from a GPS unit (e.g., the GNSS/GPS unit 4014 of FIG. 4) and lateral acceleration of the vehicle (indicating change in direction of travel of the vehicle) from an accelerometer. The behavior analyzer 4024 may receive environmental data, for example, driver gaze data from an internal camera (e.g., the internal camera(s) 4018 of FIG. 4). The behavior analyzer 4024 may record, in a memory (e.g., the memory 1340 of FIG. 1), instances of the vehicle entering turns at an excessive speed for a given radius of curvature of the turn, and determine, or detect, the deviant driving behavior after recording a predefined quantity of instances within a predefined duration.

Other examples of deviant driving behaviors include, for example, rolling stops at stop signs, failing to shift into an appropriate gear (e.g., for automatic transmission vehicles), driving too fast on bumpy roads, failing to use turn signals when changing lanes or turning, following lead vehicles too closely for a given travel speed, under- or overuse of a car horn, and so on. Specific deviant driving behaviors and respective thresholds can be established in several ways, for example, a vehicle (or component) manufacturer can define deviant driving behaviors and respective thresholds or a system (within and/or external to the vehicle) can learn deviant driving behaviors and/or their thresholds using, for example, a machine learning and/or artificial intelligence model executing on a processor within or external to the vehicle. Methods of training of machine-learning models and associated computing hardware are known in the art and are therefore not discussed further herein.

In some implementations, the behavior analyzer 4024 may store and/or retrieve driving data, environmental data, deviant driving characteristics and respective associated environmental characteristics, and/or deviant driving behaviors in a cloud storage or database (e.g., a remote non-transitory computer-readable medium), such as a storage server implemented by the computing apparatus 2410 of FIG. 2. In some implementations, the behavior analyzer 4024 may store and/or retrieve driving data, environmental data, deviant driving characteristics and respective associated environmental characteristics, and/or deviant driving behaviors according to a profile of a driver of the vehicle, where the profile may be determined by the driver performing an active authentication step, such as issuing a voice command processed by a voice-recognition unit, or by passive authentication, such as the vehicle detecting a driver-specific key that is used to start the vehicle.

The behavior analyzer 4024 is further configured to utilize user interfaces 4050 and/or user interfaces 4052, to communicate, or indicate, detection of, and/or corrective action for, deviant driving behaviors to the driver. The user interfaces 4052 are user interfaces that are integrated within the vehicle, such as graphical display of an IVI system, a vehicle audio speaker, a vehicle light (e.g., a dome light or a side-mirror light), an in-vehicle vibrating actuator (e.g., a seat vibrator or a steering-wheel vibrator), and so on. The user interfaces 4052 may be, for example one or more instances of the user interface 1350 of FIG. 1. The user interfaces 4050 are user interfaces that are not integrated within the vehicle, such as a graphical display or audio speaker of a mobile device, a tablet, a laptop, a personal computer, a smartwatch, and so on.

An example of communicating, or indicating, a detection of, and/or corrective action for, a deviant driving behavior is displaying a message on a graphical display of a mobile device or an IVI system (e.g., the user interface 1350 of FIG. 1). A specific example of an indication of a detection of a deviant driving behavior, of following lead vehicles too closely, may be a message displayed on a graphical display that says: “You're following lead vehicles too closely.” A specific example of an indication of a corrective action, for the deviant driving behavior of following lead vehicles too closely, a message displayed on a graphical display that says: “You're following lead vehicles too closely; a good distance is equivalent to a 3-second gap plus 1 second for every 10 mph over 30 mph.” The corrective action for a given deviant driving behavior may be predefined, for example, by a manufacturer of a vehicle or component thereof, or the corrective action may be learned over time by training of a machine-learning model, e.g., a neural network. Methods of training of machine-learning models and associated computing hardware are known in the art and are therefore not discussed further herein.

Once the behavior analyzer 4024 has determined a deviant driving behavior for a given driver and has communicated, or indicated, the deviant driving behavior to the driver, the behavior analyzer 4024 may provide targeted reminders of the deviant driving behavior to the driver. As described above, an indication of a corrective action may be a visual message displayed on a graphical display of an IVI system that says: “You're following lead vehicles too closely; a good distance is equivalent to a 3-second gap plus 1 second for every 10 mph over 30 mph.” A reminder of this corrective action may be a shortened visual message displayed on a windshield head-up display (HUD), or a shortened audio message played on vehicle speakers, that says: “Too close, leave at least 3 seconds.” Such a reminder may be communicated to the user every time, or a subset of every time, that the behavior analyzer 4024 detects the deviant driving characteristic(s) and respective associated environmental characteristic(s) that result in the deviant driving behavior. A targeted reminder may be a shortened, truncated, or alternative version of an indication of a corrective action. For example, an indication of a corrective action may be an audio message that says: “Check your blind spot,” and a corresponding targeted reminder may be a vibration of a left-side seat vibrator. An indication of a corrective action and/or targeted reminder may be communicated to a driver before a corresponding deviant driving characteristic may occur (a priori) or after the corresponding deviant driving characteristic occurs (a posteriori). An example of an a priori indication to check a blind spot when changing lanes may be a vibration of a left-side seat vibrator when the vehicle starts veering left immediately after driver checks the left side mirror but does not turn his head to check the left-side blind spot. an example of an a posteriori priori indication to check a blind spot when changing lanes may be an audio message asking “Did you check your blind spot?”

As shown in FIG. 4, the behavior analyzer 4024 may communicate via a communication channel 4046, by way of a cloud network 4032, to behavior change logic 4028. The behavior change logic 4028 may comprise hardware and software components, such as a mobile/web application 4030 or an in-vehicle application 4034 that may be communicatively coupled to one or more user interface devices, such as the user interface 4050 and the user interface 4052. The cloud network may be, for example, the network 2300 of FIG. 2. The mobile/web application 4030 may be executing on a mobile device, such as a smartphone or tablet, and the in-vehicle application 4034 may be executed by an IVI system. Additionally or alternatively, the behavior analyzer 4024 may communicate via a direct communication channel 4048 to the mobile/web application 4030 and it may communicate via a direct communication channel 4044 to the in-vehicle application 4034. Examples of a direct communication channels may include Wi-Fi, Bluetooth, ZigBee, and so on.

In some implementations, a driver may utilize the mobile/web application 4030 and/or the in-vehicle application 4034 to review deviant behaviors or deviant driving characteristics and respective associated environmental characteristics, which may be indexed and searchable by suitable parameters, such as by time, buy location, or by one or more behavior types or categories (e.g., safety categories, wear-and-tear categories, severity categories, frequency categories, age categories, and so on). The driver may provide driver feedback 4036 to the mobile/web application 4030, or driver feedback 4038 to the in-vehicle application 4034, via user interfaces of those devices, which may include establishing driving goals that may be based on the deviant driving characteristics and/or the deviant driving behaviors. An example of a driving goal may be specific, such as to reduce a given deviant driving behavior by 50% within 1 month, or it may be general, such as to reduce vehicle wear-and-tear. The goals are provided to the behavior analyzer 4024 by the mobile/web application 4030 and/or the in-vehicle application 4038, so that the behavior analyzer 4024 can modify its data-collection processes, data-analysis processes, and/or deviant-driving-behavior-indicating processes according to the goals. For example, given a goal to reduce vehicle wear-and-tear, the behavior analyzer 4024 may emphasize collection, analysis, and storage of driving data, such as tire pressure, gear selection, and brake temperature, that may lead to deviant driving characteristics that cause excessive wear-and-tear, such as worn tires, worn gears, and worn brakes, respectively.

For simplicity of explanation, each technique, or process, is depicted and described herein as a series of steps or operations. However, the steps or operations of the techniques in accordance with this disclosure can occur in various orders and/or concurrently. Additionally, other steps or operations not presented and described herein may be used. Furthermore, not all illustrated steps or operations may be required to implement a technique in accordance with the disclosed subject matter.

The technique 5000 described below is a technique for detecting deviant driving behaviors and indicating corrective action. These techniques may be implemented by hardware and software components integrated within or associated with a vehicle, such as the vehicle hardware components 4002 and the behavior change logic 4028 of FIG. 4.

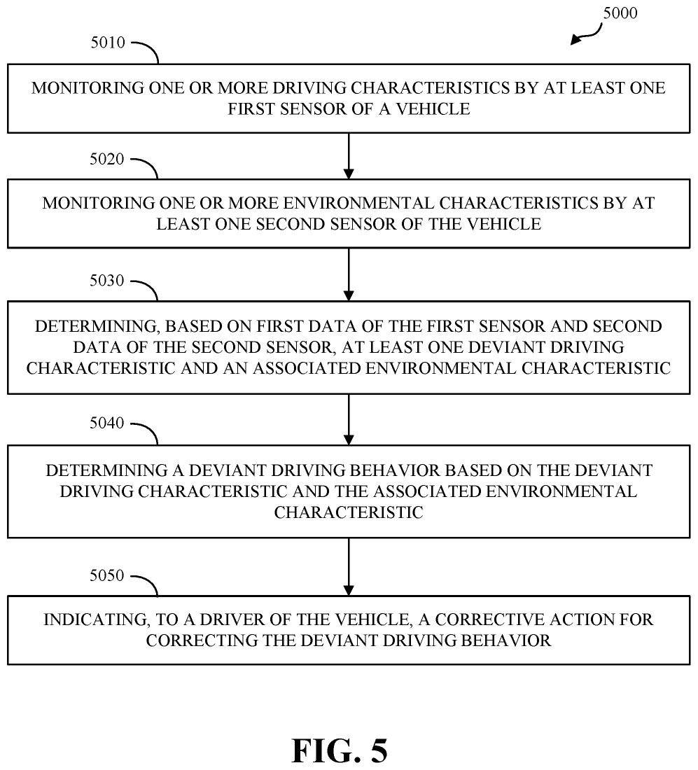

FIG. 5 is a flowchart of an example of a technique 5000 for detecting deviant driving behaviors and indicating corrective action.

The step 5010 comprises monitoring one or more driving characteristics by at least one first sensor of a vehicle. Monitoring of driving characteristics may be performed by one or more of the vehicle hardware components 4002 of FIG. 4, such as the driving-characteristics sensors 4040 that may include sensors included with or coupled to the engine control unit (ECU) 4004, the transmission control unit (TCU) 4006, the powertrain control module (PCM) 4008, the traction control unit 4010, the GNSS/GPS/mapping unit 4014, and the other in-vehicle integrated circuits (ICs) 4012.

The step 5020 comprises monitoring one or more environmental characteristics by at least one second sensor of the vehicle. Monitoring of the environmental characteristics may be performed by one or more of the vehicle hardware components 4002 of FIG. 4, such as the environmental-characteristics sensor 4042 that may include the internal camera(s) 4018, the external camera(s) 4020, and the lidar or radar 4022. As explained earlier, the GNSS/GPS/mapping unit 4014 may be included as an environmental-characteristics sensor 4042. In some implementations, the second sensor may include a sonar sensor, an ultrasonic sensor, and/or an infrared sensor.

The step 5030 comprises determining, based on first data of the first sensor and second data of the second sensor, at least one deviant driving characteristic and an associated environmental characteristic. Determination of the deviant driving characteristic and the associated environmental characteristic may be performed by the behavior analyzer 4024 of FIG. 4. The first data may comprises at least one of a vehicle speed; a vehicle acceleration; a vehicle braking; a vehicle yaw, pitch, or roll; a tire pressure; a wheel traction; a gear selection; an engine revolutions per minute; an engine temperature; a brake temperature; a tire temperature; a battery temperature; a battery state-of-charge; an undercarriage clearance; a suspension position; and so on.

The step 5040 comprises determining a deviant driving behavior based on the deviant driving characteristic and the associated environmental characteristic. In some implementations, the deviant driving behavior is stored in a non-transitory computer-readable memory for retrieval by the driver. In some implementations, the driver may retrieve the deviant driving behavior via an application, such as the mobile/web application 4030 and/or the in-vehicle application 4034 of FIG. 4.

The step 5050 comprises indicating, to a driver of the vehicle, a corrective action for correcting the deviant driving behavior. In some implementations, the indicating of the corrective action may utilize at least one of: a user interface of the vehicle, for example, the user interface 4052 of FIG. 4; or a user interface of a mobile device, for example, the user interface 4050 of FIG. 4. In some implementations, the indicating of the corrective action may utilize at least one of: a graphical display; an audio speaker; a visible light; or a vibrating actuator.

In some implementations, a further step comprises receiving an indication of a driving goal based on at least one deviant driving behavior; and increasing a frequency of indicating the corrective action to the driver. The driving goal may be received via an application, such as the mobile/web application 4030 and/or the in-vehicle application 4034. A baseline frequency of indicating the corrective action may be to indicate the corrective action to the driver every time the behavior analyzer detects an instance of a given deviant driving behavior, and an increase in frequency of indicating the corrective action may be to additionally indicate the corrective action every time the driver starts the vehicle. A frequency of indicating the corrective action need not be periodic.

In some implementations, a further step comprises indicating, to the driver, a reminder of the corrective action consisting of a shortened, truncated, or alternative version of the indicated corrective action.

The above-described techniques can be implemented as a method, a system, and a non-transitory computer-readable medium.

In an example implementation as a method, the method comprises: monitoring one or more driving characteristics by at least one first sensor of a vehicle; monitoring one or more environmental characteristics by at least one second sensor of the vehicle; determining, based on first data of the first sensor and second data of the second sensor, at least one deviant driving characteristic and an associated environmental characteristic; determining a deviant driving behavior based on the deviant driving characteristic and the associated environmental characteristic; and indicating, to a driver of the vehicle, a corrective action for correcting the deviant driving behavior.

In some implementations, the method further comprises: indicating the corrective action by at least one of: a user interface of the vehicle; or a user interface of a mobile device.

In some implementations, the method further comprises indicating the corrective action by at least one of: a graphical display; an audio speaker; a visible light; or a vibrating actuator

In some implementations, the method further comprises: storing at least one deviant driving behavior in a non-transitory computer-readable memory for retrieval by the driver.

In some implementations, the method further comprises: receiving an indication of a driving goal based on at least one deviant driving behavior; and increasing a frequency of indicating the corrective action to the driver

In some implementations, the method further comprises: indicating, to the driver, a reminder of the corrective action consisting of a shortened, truncated, or alternative version of the indicated corrective action.

In some implementations, the first data comprises at least one of: a vehicle speed; a vehicle acceleration; a vehicle braking; a vehicle yaw, pitch, or roll; a tire pressure; a wheel traction; a gear selection; an engine revolutions per minute; an engine temperature; a brake temperature; a tire temperature; a battery temperature; a battery state-of-charge; an undercarriage clearance; or a suspension position.

In some implementations, the method further comprises: an interior camera; an exterior camera; a lidar; a radar; a sonar; an ultrasonic sensor; an infrared sensor; or a global navigation satellite system.

In another example implementation as a non-transitory computer-readable medium, the non-transitory computer-readable medium stores instructions operable to cause one or more processors to perform operations comprising: monitoring one or more driving characteristics by at least one first sensor of a vehicle; monitoring one or more environmental characteristics by at least one second sensor of the vehicle; determining, based on first data of the first sensor and second data of the second sensor, at least one deviant driving characteristic and an associated environmental characteristic; determining a deviant driving behavior based on the deviant driving characteristic and the associated environmental characteristic; and indicating, to a driver of the vehicle, a corrective action for correcting the deviant driving behavior

In some implementations, the operations further comprise indicating the corrective action by at least one of: a user interface of the vehicle; or a user interface of a mobile device.

In some implementations, the operations further comprise: indicating the corrective action by at least one of: a graphical display; an audio speaker; a visible light; or a vibrating actuator.

In some implementations, the operations further comprise: storing at least one deviant driving behavior in a second non-transitory computer-readable memory for retrieval by the driver.

In some implementations, the operations further comprise: receiving an indication of a driving goal based on at least one deviant driving behavior; and increasing a frequency of indicating the corrective action to the driver.

In some implementations, the operations further comprise: indicating, to the driver, a reminder of the corrective action consisting of a shortened, truncated, or alternative version of the indicated corrective action.

In another example implementation as a system, the system comprises one or more memories; and one or more processors configured to execute instructions stored in the one or more memories to: monitor one or more driving characteristics by at least one first sensor of a vehicle; monitor one or more environmental characteristics by at least one second sensor of the vehicle; determine, based on first data of the first sensor and second data of the second sensor, at least one deviant driving characteristic and an associated environmental characteristic; determine a deviant driving behavior based on the deviant driving characteristic and the associated environmental characteristic; and indicate, to a driver of the vehicle, a corrective action for correcting the deviant driving behavior.

In some implementations, the instructions include instructions to: indicate the corrective action by at least one of: a user interface of the vehicle; or a user interface of a mobile device.

In some implementations, the instructions include instructions to: indicate the corrective action by at least one of: a graphical display; an audio speaker; a visible light; or a vibrating actuator.

In some implementations, the instructions include instructions to: store at least one deviant driving behavior in a non-transitory computer-readable memory for retrieval by the driver.

In some implementations, the instructions include instructions to: receive an indication of a driving goal based on at least one deviant driving behavior; and increase a frequency of indicating the corrective action to the driver.

In some implementations, the instructions include instructions to: indicate, to the driver, a reminder of the corrective action consisting of a shortened, truncated, or alternative version of the indicated corrective action.

As used herein, the terminology “example,” “embodiment,” “implementation,” “aspect,” “feature,” or “element” indicates serving as an example, instance, or illustration. Unless expressly indicated, any example, embodiment, implementation, aspect, feature, or element is independent of each other example, embodiment, implementation, aspect, feature, or element and may be used in combination with any other example, embodiment, implementation, aspect, feature, or element.

As used herein, the terminology “determine” and “identify,” or any variations thereof, includes selecting, ascertaining, computing, looking up, receiving, determining, establishing, obtaining, or otherwise identifying or determining in any manner whatsoever using one or more of the devices shown and described herein.

As used herein, the terminology “or” is intended to mean an inclusive “or” rather than an exclusive “or”. That is, unless specified otherwise, or clear from context, “X includes A or B” is intended to indicate any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form.

Further, for simplicity of explanation, although the figures and descriptions herein may include sequences or series of steps or stages, elements of the methods disclosed herein may occur in various orders or concurrently. Additionally, elements of the methods disclosed herein may occur with other elements not explicitly presented and described herein. Furthermore, not all elements of the methods described herein may be required to implement a method in accordance with this disclosure. Although aspects, features, and elements are described herein in particular combinations, each aspect, feature, or element may be used independently or in various combinations with or without other aspects, features, and elements.

The above-described aspects, examples, and implementations have been described to allow easy understanding of the disclosure are not limiting. On the contrary, the disclosure covers various modifications and equivalent arrangements included within the scope of the appended claims, which scope is to be accorded the broadest interpretation to encompass all such modifications and equivalent structure as is permitted under the law.

What is claimed is:

1. A method, comprising:
monitoring one or more driving characteristics by at least one first sensor of a vehicle;
monitoring one or more environmental characteristics by at least one second sensor of the vehicle;
determining, based on first data of the first sensor and second data of the second sensor, at least one deviant driving characteristic and an associated environmental characteristic;
determining a deviant driving behavior based on the deviant driving characteristic and the associated environmental characteristic; and
indicating, to a driver of the vehicle, a corrective action for correcting the deviant driving behavior.

2. The method of claim 1, further comprising:
indicating the corrective action by at least one of:
a user interface of the vehicle; or
a user interface of a mobile device.

3. The method of claim 1, further comprising:
indicating the corrective action by at least one of:
a graphical display;
an audio speaker;
a visible light; or
a vibrating actuator.

4. The method of claim 1, further comprising:
storing at least one deviant driving behavior in a non-transitory computer-readable memory for retrieval by the driver.

5. The method of claim 1, further comprising:
receiving an indication of a driving goal based on at least one deviant driving behavior; and
increasing a frequency of indicating the corrective action to the driver.

6. The method of claim 1, further comprising:
indicating, to the driver, a reminder of the corrective action consisting of a shortened, truncated, or alternative version of the indicated corrective action.

7. The method of claim 1, wherein the first data comprises at least one of:
a vehicle speed;
a vehicle acceleration;
a vehicle braking;
a vehicle yaw, pitch, or roll;
a tire pressure;
a wheel traction;
a gear selection;
an engine revolutions per minute;
an engine temperature;
a brake temperature;
a tire temperature;
a battery temperature;
a battery state-of-charge;
an undercarriage clearance; or
a suspension position.

8. The method of claim 1, wherein the second sensor comprises at least one of:
an interior camera;
an exterior camera;
a lidar;
a radar;
a sonar;
an ultrasonic sensor;
an infrared sensor; or
a global navigation satellite system.

9. A non-transitory computer-readable medium storing instructions operable to cause one or more processors to perform operations comprising:
monitoring one or more driving characteristics by at least one first sensor of a vehicle;
monitoring one or more environmental characteristics by at least one second sensor of the vehicle;
determining, based on first data of the first sensor and second data of the second sensor, at least one deviant driving characteristic and an associated environmental characteristic;
determining a deviant driving behavior based on the deviant driving characteristic and the associated environmental characteristic; and
indicating, to a driver of the vehicle, a corrective action for correcting the deviant driving behavior.

10. The medium of claim 9, the operations further comprising:
indicating the corrective action by at least one of:
a user interface of the vehicle; or
a user interface of a mobile device.

11. The medium of claim 9, the operations further comprising:
indicating the corrective action by at least one of:
a graphical display;
an audio speaker;
a visible light; or
a vibrating actuator.

12. The medium of claim 9, the operations further comprising:
storing at least one deviant driving behavior in a second non-transitory computer-readable memory for retrieval by the driver.

13. The medium of claim 9, the operations further comprising:
receiving an indication of a driving goal based on at least one deviant driving behavior; and
increasing a frequency of indicating the corrective action to the driver.

14. The medium of claim 9, the operations further comprising:
indicating, to the driver, a reminder of the corrective action consisting of a shortened, truncated, or alternative version of the indicated corrective action.

15. A system, comprising:
one or more memories; and
one or more processors configured to execute instructions stored in the one or more memories to:
monitor one or more driving characteristics by at least one first sensor of a vehicle;
monitor one or more environmental characteristics by at least one second sensor of the vehicle;
determine, based on first data of the first sensor and second data of the second sensor, at least one deviant driving characteristic and an associated environmental characteristic;
determine a deviant driving behavior based on the deviant driving characteristic and the associated environmental characteristic; and
indicate, to a driver of the vehicle, a corrective action for correcting the deviant driving behavior.

16. The system of claim 15, the instructions including instructions to:
indicate the corrective action by at least one of:
a user interface of the vehicle; or
a user interface of a mobile device.

17. The system of claim 15, the instructions including instructions to:
indicate the corrective action by at least one of:
a graphical display;
an audio speaker;
a visible light; or
a vibrating actuator.

18. The system of claim 15, the instructions including instructions to:
store at least one deviant driving behavior in a non-transitory computer-readable memory for retrieval by the driver.

19. The system of claim 15, the instructions including instructions to:
receive an indication of a driving goal based on at least one deviant driving behavior; and
increase a frequency of indicating the corrective action to the driver.

20. The system of claim 15, the instructions including instructions to:
indicate, to the driver, a reminder of the corrective action consisting of a shortened, truncated, or alternative version of the indicated corrective action.
